(19) United States
(12) Patent Application Publication
(10) Pub. No.: US 2020/0358672 A1
(43) Pub. Date: Nov. 12, 2020

(54) MANAGED PUBLIC CLOUD

(71) Applicant: Atos Information Technology GmbH, München (DE)

(72) Inventor: Marcus LANGE, Neumarkt (DE)

(21) Appl. No.: 16/954,695

(22) PCT Filed: Dec. 18, 2018
(86) PCT No.: PCT/EP2018/085487

§ 371 Date: Jun. 17, 2020

(30) Foreign Application Priority Data
Dec. 19, 2017 (FR) 1762543

(51) Int. Cl. H04L 12/24; H04L 29/08; H04L 12/14; H04L 29/06; H04L 29/12

(52) U.S. Cl. CPC H04L 41/5045; H04L 67/1002; H04L 41/22; H04L 61/1511; H04L 12/1414; H04L 63/02; H04L 41/5096

(57) ABSTRACT

System for Managing Public Cloud (1) comprising at least a software and hardware arrangement for Basic support (or package A), said arrangement allowing to: Display on digital forms configuration questions and to fill up the forms Enable Centralized Billing and Reporting Decide on Security Functionality required among the selected choices Secured Global Account. (Owner Level) (Azure®) Secured Root Account (AWS®) Collection of audit logs with secure storage and retention Determine thresholds for giving Alert on Cloud Billing.

### TECHNICAL FIELD OF THE INVENTION

The invention relates to the field of Managed Public Cloud.

### STATE OF THE PRIOR ART

US2015026349 relates to a CSB (cloud service brokerage) which is a third party company, or Enterprise IT Cloud Administration Organization, that adds value to cloud services on behalf of cloud service consumers. The goal of a CSB is to make the service more specific to a company, or to integrate or aggregate services, to enhance their security, to establish and manage contract based pricing, or to do anything that adds a significant layer of value (i.e. capabilities) to the original cloud services being offered. By employing the cloud services wizard (which can include an application screener) to assess information derived from a knowledge base of information based on experience and best practices and to calculate CUs for various cloud service providers, the CSB platform user is guided towards an apples-to-apples comparison that results in the closest matched cloud services and cloud service providers. It is a cloud service brokerage employing a cloud services wizard to help compare cloud service providers. Each user need to use the wizard to compare offers in order to choose which services he wants. There is no standard options from which companies can choose relative to the levels of governance and responsibility of their users.

The benefits of cloud are clear, but businesses have to make critical decisions as to where they run their workloads. This may raise difficulties for not highly skilled staff in this field.

As circumstances change, workloads will need to move between clouds.

Flexibility and ease of migration placement across multiple private and public clouds and devices is vital.

Highly skilled staff is required on set-up environments and enabling of enterprise applications.

Set-up, translate customer compliancy and security standards into a reference architecture and to securely and privately connect Amazon Web Services (AWS®) or AZURE® to the customer network via VPC setup and configuration.

AWS® or AZURE® doesn't have all service options required for enterprise applications, e.g. backup (application aware).

In moving to the cloud, enterprises are looking to improve their IT delivery and reduce their costs, without sacrificing any of the functionality, security or quality of service they currently receive from traditional IT delivery. Security is often one of the key inhibitors to public cloud adoption. Public cloud providers fall short of this requirement, and moving towards Managed Public Cloud is complex with no standard end-to-end solutions.

Application integration in a public cloud is also harder than before, and demands expertise that most enterprises or cloud providers do not have. Public cloud is designed mainly for consumers, and less for enterprise use.

Set-up, translate customer compliancy and security standards into a reference architecture and to securely and privately connect Amazon Web Services (AWS®) or AZURE® to the customer network via VPC setup and configuration.

Moreover AWS® or AZURE® doesn't have all service options required for enterprise applications, e.g. backup (application aware).

Current challenges in organizations using the public cloud are:
The customer has to monitor, control and configure security settings to ensure data security and compliance in the cloud.
Cloud Services provide Developers and Testers with an innovative, immediately available platform, where it is easy to order services using the Company Credit card. Customers need to control this expenditure and ensure the security of their intellectual property. Without proper controls IT spending can be wasted, IT infrastructure bills may not be paid on time and the business may not have proper control of its assets.
Customers need different portals for each infrastructure provider, each using different terms and conditions with the high costs of managing these.
To use more than one public cloud provider the customer needs to implement governance processes for each of these providers.
Customers need to create a skilled Cloud Management Team comprising a full set of management functions, which are separated in the traditional world, in one comprehensive team. The necessary skills need to be obtained and trained for every public cloud being used.

Managed Public Cloud of the present invention addresses these challenges by providing a trusted interface into the cloud. From that trusted interface:
You can transform your business' legacy applications;
Develop new cloud applications, and;
Analyze business data.

### DISCUSSION OF THE INVENTION

The present invention therefore has the object of proposing a system for Managing Public Cloud (or MPC), giving the possibility of overcoming at least one portion of the drawbacks of the prior art.

The system for Managing Public Cloud comprising at least a software and hardware arrangement for Basic support (or package A), said arrangement enabling a user to connect to the system for creating at least an account and to execute or provide two of the following:
Display on user terminal digital configuration forms and to let fill up the forms by the user and memorize on the memory space attached to the user account such reply after validation by the user and offering options to select different service packages,
Enable Centralized Billing and Reporting;
Decide on Security Functionality required among selected choices made and memorized on the memory space attached to the user account;
to Collect audit logs with secure storage and retention
Determine thresholds for giving Alert on Cloud Billing, said thresholds being determined by user and memorized on the memory space attached to the user account and to a service package selected.

System for Managing Public Cloud wherein said arrangement enables said user to select at least one Standard Service Requests (SSRs) or at least one set of SSRs, said SSRs memorized on the memory space attached to the user account and to a service package selected.

System for Managing Public Cloud wherein said arrangement is offering to a user the choice of a second option B (or package B) which allows the user to determine in addition:

Automated creation and management of a virtual network environment with following minimal settings by using the memorized reply of a user for establishing:
Two availability zones: Public Subnet, Private Subnet
Internet Gateways
Static Firewall configurations
VPN/WAN Connectivity.

System for Managing Public Cloud wherein said arrangement is offering to a user the choice of a third option C (or package C) which allows the user to determine in addition:
to control or execute all functionality via a Business Portal.
the Customizable approval workflows support customers governance (Azure® only)
select and execute Standard Service Requests allowing the control of various cloud services
to Compute Instances
to manage and control DB Instances (AWS® only)
to Compute Storage and backup functions (Azure®: restore within console—manually)
to determine the Firewall settings (policies)
to define the Load balancing configurations (AWS® only)
DNS (AWS® only)
to integrate all deployed objects into MPC management framework
to control for all objects monitoring, security and availability
to Compute Instances in Operating system managed by customer or ordered on top of this Package.

The system for MPC wherein the choice of service can be made on an account-by-account basis,

The system for MPC will use Atlassian Bitbucket for source control;
One repository will be created for the MPC Azure Product;
One repository will be created for the Customer Definitions and delta's.

System for Managing Public Cloud wherein said arrangement offers the choice of few operational tasks performed by MPC-AWS® which are listed such as:
Creation of new VPC's (VPC, Virtual Private Cloud)
Creation of new Subnet's in VPC's
On-Going Management of Subnet's in VPC's
Documentation of Subnet usage and intended purposes
Creation of route tables
Creation of Security Groups as part of a project
Creation of Security Groups outside of a project

The invention is also related to a method for managing Public Cloud which includes an hardware and software arrangement for executing at least one the following steps:
Displaying digital configuration forms and prompting user to fill up the forms
Deciding on Security Functionality required among selected choices
Propose a Secured Global Account. (Owner Level) (Azure®)
Propose a Secured Root Account (AWS®)
Collecting of audit logs with secure storage and retention
Determine Alert thresholds for giving Alert on Cloud Billing
Automated creation and management by MPC of a virtual network environment with following at least one of the minimal settings:
   One repository created for the MPC Azure Product;
   One repository created for the Customer Definitions and delta's.
   Two availability zones: Public Subnet, Private Subnet
   Internet Gateways
   Static Firewall configurations
   VPN/WAN Connectivity.

Method for managing Public Cloud which includes an hardware and software arrangement for executing at least one the following steps:
Control or execute all functionality via Business Portal.
the Customizable approval workflows support customers governance (Azure®)
Select and execute Standard Service Requests allowing the control of various cloud services
Compute Instances
Manage and control DB Instances (AWS®)
Compute Storage and backup functions (Azure®: restore within console—manually)
Determine the Firewall settings (policies)

### SHORT DESCRIPTION OF THE FIGURES

Other features, details and advantages of the invention will become apparent upon reading the description which follows with reference to the appended figures, which illustrate:

FIG. 1, illustrates the options available for the management of a public cloud on a platform

FIG. 2 represents the position of the MPC in a service stack.

FIG. 3 represents use of managing public cloud software in a system for providing a MPC service called CANOPY®.

FIG. 4 represents the automation architecture of the managing public cloud (MPC) system with Azure.

FIG. 5 represents the different subscriptions of 2 different customers from a unique CSP Account

### DETAILED DESCRIPTION OF DIFFERENT EMBODIMENTS OF THE INVENTION

A user may connect on web to a MPC server to obtain credential to access a Managed Public Cloud service. The MPC offers several options to the customer.

The Managed Public Cloud (MPC) service (1) provides customers a layered approach for the management of a public cloud infrastructure (2) and the workloads contained within. The layers vary from a standard account that the customer can use to perform all their customizations, to a fully managed environment where common requests can be made through a service catalogue with options.

The choice of service can be made on an account-by-account basis, meaning that customers can choose to have a Foundation service in a sandbox account, whilst choosing full Instance Management for production purposes.

Managed Public Cloud service can be delivered quickly worldwide using cloud management sites in either Poland or other operational center(s) where required.

MPC is a multi-cloud service offering management for Microsoft Azure, Azure Stack as well as Amazon Web Services.

MPC is also a part of hybrid cloud, where customers can easily integrate the solution with private cloud services from Atos or other third parties. This ensures workloads can be placed optimally to meet cost, infrastructure security and availability requirements, by defining the Load balancing configurations and by determining thresholds for giving Alert on Cloud Billing.

Many combinations may be contemplated without departing from the scope of the invention; one skilled in the art will select either one depending on economical, ergonomical, dimensional constraints or others which he/she will have observed.

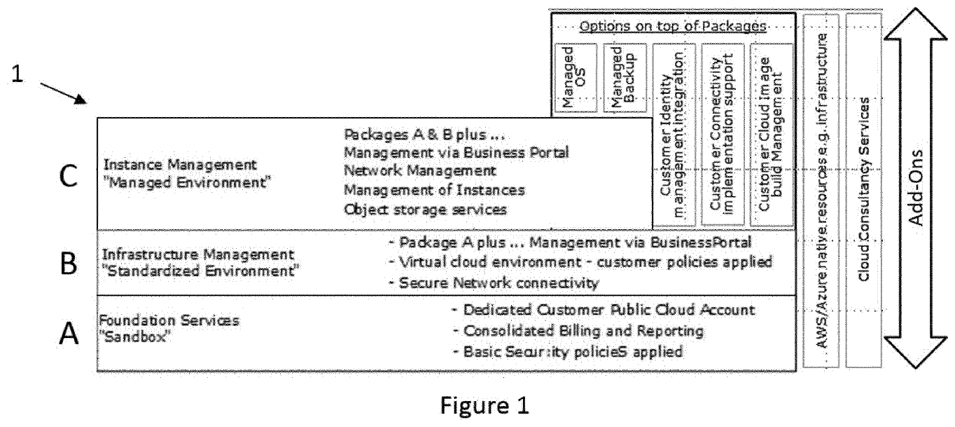

More particularly, according to an embodiment illustrated by FIG. 1, the MPC comprises at least:
a Cloud controller, that is a storage appliance that automatically moves data from on-premises storage to cloud storage,
a Service Broker required to integrate any service with a Cloud Foundry instance,
a Service Backend constituted by several Service instances, each linked to at least one Application, in a Droplet Execution Agent pool (DEA pool),
   which is responsible for running all applications, monitors all applications(CPU, Memory, IO, Threads, Disk, FDs, etc.),all applications looking the same for DEA, for expressing ability and desire to run an application (runtimes, options, cluster avoidance, memory/cpu), alerting on any change in state of applications, providing secure/constrained OS runtime (hypervisor, unix file and user, linux containers, single or multi-tenant).

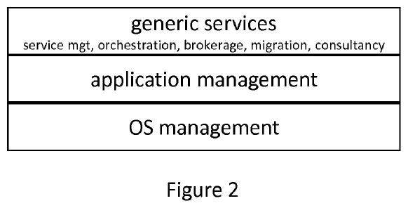

As shown by the FIG. 2, the MPC software (1) fits between the OS management and the Public Cloud Infrastructure in the service stack. MPC software include different modules at this position: console, architecture, catalogue, monitoring and compliancy. The Data center, network storage, server and virtualization are included in the Public Cloud Infrastructure (2) for example Microsoft AZURE® or Amazon AWS®.

The MPC service offers three options to the customer.

Foundation service is Basic support/package A which is the entry level service allowing by a combination of hardware and software arrangement the use of all native cloud functionality via cloud API/console

The Customer receives an account with permissions to add and manage additional accounts and account privileges in self-management.

Basic support or package A is limited to:
Configuration questions. Today this is done via a set of onboarding workshops, captured via spreadsheets that in turn is used to drive JSON based configuration files.
Centralized Billing and Reporting
Security Functionality. Several Options are available and selectable depending on customer requirements;
Secured Global Account. (Owner Level) (Azure® or
Secured Root Account (AWS®)
Collection of audit logs with secure storage and retention; Storage is the place where collection is stored, retention is the policy around how long they are stored for. The logs are stored with restricted access, meaning you need specific permissions to be able to look at them, and no one can delete them.
Alert on Cloud Billing threshold.

JSON based configuration files are used by MPC to determine whether AZURE® cloud (2) or AWS® Cloud (2) or a third private cloud should be used and enable user to access AZURE® or AWS® set of Standard Service Requests (SSRs) to make its selection of services.

In addition to Package A the system for Managing Public Cloud (1) offers a second option B which allows on said arrangement: Automated creation and management of a virtual network environment by using captured information from the customer requirements which is fed into scripts that configure each account as required:

with at least one of the following minimal settings:
Two availability zones: Public Subnet, Private Subnet;
Internet Gateways;
Static Firewall configurations;
VPN/WAN Connectivity.

The virtual machines of the at least one public cloud managing system control engine, the at least one network node device of the cloud, or the at least one virtual network environment are configured to execute portions of the specific settings, wherein the portions of the specific settings are distributed based on capacity and efficiency characteristics of the respective virtual machine of the at least one public cloud managing system control engine, the at least one network node device of the cloud, or the at least one virtual network environment.

Changes to the cloud environment are controlled through a Business portal by an hardware and software arrangement. One Cloud Account can have only one Service Variant selected A or B or C.

Customer receives an account to self-manage accounts. Rights are limited to services not managed by Managing Public Cloud system (1) and can be accessed via native cloud console/API.

The customers are informed on Technical updates applied to the service by an update hardware and software downloading arrangement.

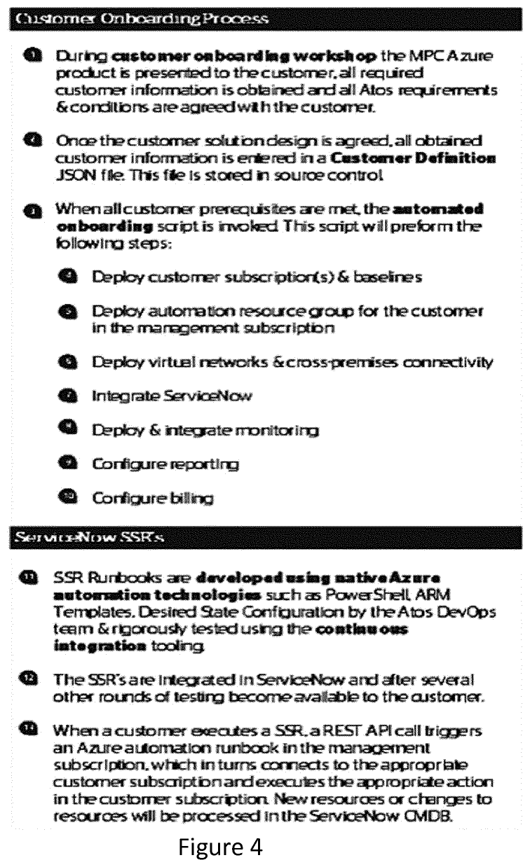

Customer can have many cloud accounts with different Service packages, as represented in FIG. 4.

In addition to the both here above options a third option C allows by an hardware and software arrangement:
to control or execute all functionality via Business Portal.
the Customizable approval workflows support customers governance (Azure® only)
Standard Service Requests allows the control of various cloud services
to Compute Instances
DB Instances (AWS® only)
to Compute Storage and backup functions (Azure®: restore within console—manually)
the Firewall settings (policies)
the Load balancing configurations (AWS® only)
DNS (AWS® only)
to integrate all deployed objects into MPC management framework
to control for all objects monitoring, security and availability
to Compute Instances in Operating system is managed by customer or can be ordered on top of this Package.

One of the key differences between package B and package C subscriptions involves the responsibility model. With package C, MPC service provider, such as Atos, has full responsibility and control over the subscription, enabling customers to focus on their core business, and simply consume managed Azure® services through fully automates Self Service Requests in ServiceNow (3). For customers that need to have more control over the Azure environment package B might be more suitable. Scenarios include but are not limited to customers that have a CI/CD process in place or use a different ITSM product and do not want to integrate with ServiceNow.

MPC Azure Package B is built around a shared responsibility model where Atos is still responsible for most of the foundational services, such as Azure subscription governance, networking, and monitoring, but the customer can be delegated control at resource group level to enable them to deploy and manage their own resources through the Azure portal and restful API's

The MPC Service is operated centrally, by a MPC-provider, which provides an hardware and software arrangement for:
Engineering and cloud operations support on the service with trained/skilled staff
AWS® supports with L4 skilled team
All Cloud functionality is executed remotely by using the AWS® console
Managed OS on instances on top of MPC needs to be delivered by local GBU
Modules with needed customer interaction to deliver the service option:
Managed Customer Connectivity
Federation Solution

Visual Studio Team Services (VSTS) is used as the integration point between Bitbucket and Azure & Continuous Integration/Continuous Delivery.

Atlassian Bitbucket will be used for source control. All code developed must be committed to the source control repository. Bitbucket is the standard source control used within MPC service. Bitbucket integrates with Jira and Confluence.

Bitbucket is a web-based version control repository hosting service owned by Atlassian.

Bitbucket need to use clear structure to avoid any ambiguity, it must be clear where to store/find a particular type of artifact.

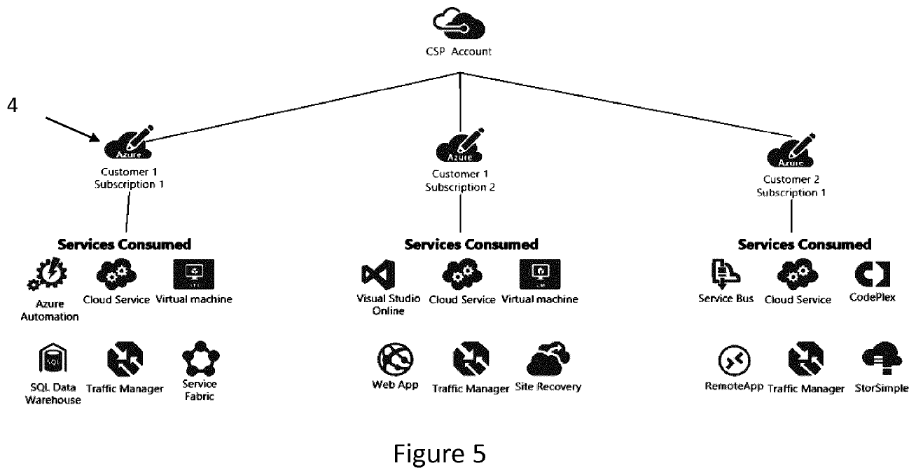

Source Control: All code developed must be stored in a source control repository. MPC service will use Atlassian Bitbucket for source control.
One repository will be created for the MPC Azure Service or for MPC AWS Service depending on selections made by customer;
One repository (4) will be created for each different Customer Definitions and Subscriptions (subscription 1 or 2 of customer 1, as shown on FIG. 5) and delta's.

The managing public cloud system (1) comprises an hardware and software arrangement for enabling user to select one or several service requests among a set of Standard Service Requests (SSRs) adapted either for AWS® or for AZURE® and thereafter to send these requests either to AWS® or AZURE® for implementation.

Each account can select different sets of SSRs, chosen in regard of the role the user will have. Thus, with this system for MPC, the choice of SSRs can be made on an account-by-account basis.

Several SSRs, or a set of SSRs can be specific to security functionality, and to decide which one is required among selected choices made by user and memorized on the memory space attached to the user account, while others SSRs, or another set, can be specific to collect audit logs with secure storage and retention.

In some embodiments, SSRs can be selected to execute or provide any of the following:
Display on user terminal digital configuration forms and to let fill up the forms by the user and memorize on the memory space attached to the user account such reply after validation by the user;
Enable Centralized Billing and Reporting;
Decide on Security Functionality required among selected choices made by user and memorized on the memory space attached to the user account;
Propose a Secured Global Account. (Owner Level) (Azure)
Propose a Secured Root Account (AWS)—Collect audit logs with secure storage and retention;
Determine thresholds for giving Alert on Cloud Billing, said thresholds being determined by user and memorized on the memory space attached to the user account.

Thanks to that, each user can select a specific package and specific SSRs, adapting the possibilities of his account to the user's role.

AWS® Standard Service Requests (SSRs) are grouped in Clusters:
To effect Computation related to virtual machines, VM firewall rules, storage and backup
To manage Database: related to RDS (relational database service) and snapshots/backup
To effect Object Storage: related to S3 requests
To manage Environment: related to VPC (Virtual Private Cloud) requests
To manage Load balancer: related to Load balancer configurations

In addition, Custom Tags and Cost Center can be added to SSRs when creating the resource to enable comprehensive billing reporting.

A high level of automation is established in MPC AWS® services by an hardware and software arrangement:
VPC deployment & configuration, VPC peering between MPC-provider tooling and customer resource accounts, S3 bucket policies based on accounts, IAM VPC peering based on accounts, Auto tagging of AWS® assets
Most SSRs are fully automated

AWS® set of Standard Service Requests (SSRs) can be:
Add Storage Virtual Server
Change Owner of Virtual Server
Create Snapshot
Delete Storage Virtual Server
Delete Virtual Server
Delete Snapshot
Expand Storage Virtual Server
Power On/Off or Restart Virtual Server
Create an Image from a Snapshot
Change Virtual Server T-shirt size
Create Virtual Server
Change Security Group Virtual Server
Create Load Balance
Delete Load Balance
Change Load Balancer Health Check policy
Add or Remove Instance to a Load Balancer
Create or Change Object Storage Lifecycle policy
Add or Remove Security Group to a Load Balancer
Request Key Pair
Create Relational Database
Delete Relational Database
Restart Relational Database
Snapshot Relational Database
Change Relational Database
Restore Relational Database
Delete Object Storage bucket
Create Object Storage bucket
Create IAM user account
Delete IAM user account
Copy Virtual Server
Virtual Server Service Generic Request
Extend lease period
Relational Database Service Generic Request
Delete Network Security Group
Create or Modify DNS Zone
Network Service Generic Request
Create Network
Object Storage Service Generic Request
Detach Storage Virtual Server
Create Volume from Snapshot
Restore a Volume from a Snapshot
Backup Virtual Server and applications
Create Amazon Account
Load Balancer Service Generic Request

AZURE® set of Standard Service Requests (SSRs) are grouped in Clusters for
Virtual Machine: related to virtual machines
Storage: snapshots/backup
Snapshot: related to VM Snapshots
Scheduled Actions: scheduled start/stop requests
Backups: Scheduled and ad-hoc backup and restore requests
OMS: monitoring related requests

AZURE® set of Standard Service Requests (SSRs) can be:
Create Resource Group
Change Resource Group
Create Virtual Server
Start Virtual Server
Restart Virtual Server
Stop Virtual Server
Change Virtual Server T-shirt size
Change Virtual Server Region
Delete Virtual Server
Change Virtual Server Management
Add Storage Virtual Server
Expand Storage Virtual Server
Delete Storage Virtual Server
Create Snapshot
Restore Snapshot
Delete Snapshot
Create Schedule for Virtual Server
Edit Schedule for Virtual Server
Delete Schedule for Virtual Server
Restore Backup of a Virtual Server
Create Ad-hoc Backup

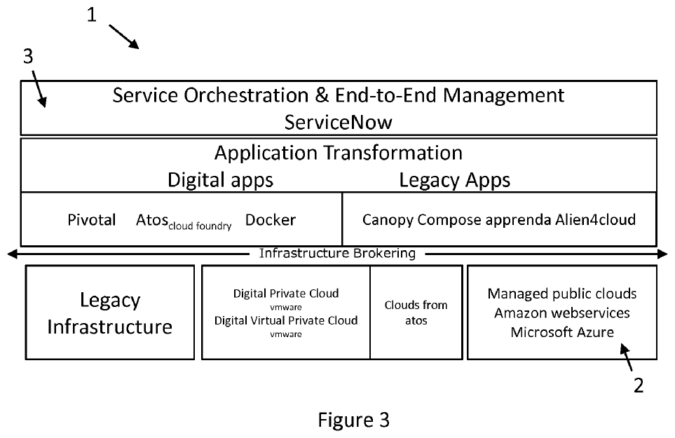

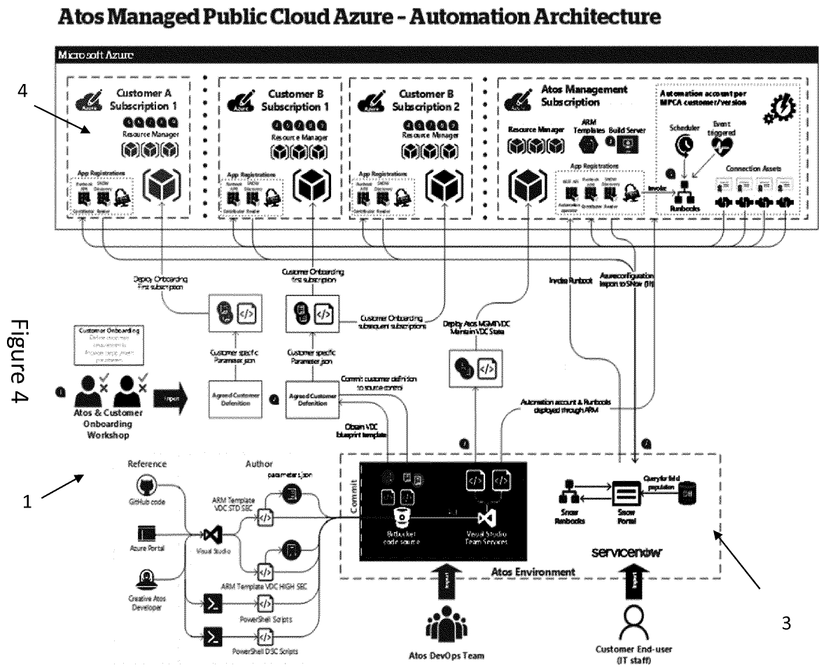

FIG. 3 shows the use of managing public cloud software in a system for implementing a service called CANOPY® enabling the use and operation of an orchestrated hybrid cloud platform.

The managing public cloud software used in CANOPY® is integrated in the second application layer to orchestrate public cloud.

First layer represent a service software executed on at least a processor of a platform to orchestrate services on behalf of a customer and make end to end management in the hybrid cloud through dialog with a second layer of several integrated software for application transformation and a third layer of other integrated software for infrastructure brokering with the different private or public clouds managed by the integrated software such as VMware® for a private cloud, and AZURE®, or AWS® for a public cloud.

The full list of operational tasks to be executed by MPC to switch on AWS® cloud is listed here below:
Development of VPC Engineering Standards
Approval of VPC Engineering Standards
Creation of new VPC's
Creation of new Subnet's in VPC's
On-Going Management of Subnet's in VPC's
Approval of Subnet changes
Documentation of Subnet usage and intended purposes
Creation of route tables
Modification of route tables
Approval of route table changes
Creation of Security Groups as part of a project
Creation of Security Groups outside of a project
Approval of the creation/modification of Security groups
Modifying Security Groups
Maintenance of Security Group documentation
Creation of HA-Proxy instances
Maintenance of HA-Proxy Instances
CSR generation for SSL maintenance
Importation of SSL certs into HA-Proxy
Creation of NAT instances
Maintenance of NAT instances
Documentation of NAT instances
Termination of NAT instances
Creation of Internet Gateways
Maintenance of Internet Gateways
Termination of Internet Gateways
Creation of AWS® Console Accounts
Domain Name Registration
Route 53 Hosted Zone creation
Route 53 Hosted Zone maintenance
Route 53 Hosted Zone deletion
Approval of Route 53 Add/Modify/Delete
Route 53 Health Check Creation
Route 53 Health Check Modify
Route 53 Health Check Delete
Route 53 and ELB integration
Establishment of Route 53 Standards
Approval of Route 53 standards
Creation of ELBs
Modification of ELB Health Checks
Modification of ELB Targets
Deletion of ELBs
Documentation of ELB configuration
Approval of ELB Add/Delete/Modify
Development of ELB Standards
Integration of ELB with Route 53 Health checks
Creation of CSR for SSL cert creation
Order of SSL Cert
Installation of SSL Cert
Creation of S3 Bucket
Support end users to be able to upload objects into S3 Bucket
Approval of S3 usage and Bucket creation
Uploading of S3 objects
Moving of S3 objects
Deletion of S3 objects
Deletion of S3 buckets
Creation of IAM polices of S3
Creation of AWS® Console accounts for S3 Access
Approval of S3 account creation
Creation of EC2 Instances as part of a project
Creation of EC2 Instances outside of a project
Modification of EC2 instances
Instance Power On/Hard Power Off/Reset
Creation of EBS Volumes as part of a project
Creation of EBS Volumes outside of a project
Creation of EC2 Tagging
Changes to EC2 Tagging
EBS Snapshot Setup
EBS Snapshot Maintenance/Cleanup
Deletion of EC2 Instances
Set EC2 standards
Approval of EC2 standards
Generation of Key Pairs
Creation of DB Instances
Modification of DB Instances
Snapshot Maintenance
DBMS Modification
Deletion of DB Instances
Set RDS Standards
Approval of RDS Standards
   In addition MPC service provider, such as Atos, offers a variety of add-on services, which are either relevant to an account, or an individual workload. Such examples of value added services are:
Customer onboarding to the Atos Managed Public Cloud Services.
Customer Image Management—Packages Server/Application images for Variant C runnable at the respective public cloud.
Managed Customer Connectivity—Creates a private connection with customer network with VPN configurations or via a private VPN connection to the public cloud service provider datacenter on a project base.
Customer Federation Solutions—Integrate an external Identity Management system
Customer Server Migrations—Migrate workload from and to public cloud on a project managed basis
Managed High Complexity Backup—Agents running on the virtual machine enable an application aware backup.
OS Management—Availability, Security, Patch management up to the operating system (available on project basis)
DNS Management—Configures and xxxxx public cloud service provider DNS service.
Instance Backup—Backup of virtual machines with cloud native methods
Managed Object Storage—provides object storage (S3-AWS or Blob-Azure) to deployed virtual machines

It will be easily understood upon reading the present application that the particularities of the present invention, as generally described and illustrated in the figures, may be arranged and designed according to a great variety of different configurations. Thus, the description of the present invention and the related figures are not provided for limiting the scope of the invention but simply illustrating selected embodiments.

One skilled in the art will understand that the technical features of a given embodiment may in fact be combined with features of another embodiment unless the opposite is explicitly mentioned or if it is obvious that these features are incompatible. Further, the technical features described in a given embodiment may be isolated from the other features of this embodiment unless the opposite is explicitly mentioned.

It should be obvious for persons skilled in the art that the present invention allows embodiments under many other specific forms without departing from the field defined by the scope of the appended claims, these embodiments should be considered as an illustration and the invention should not be limited to the details given above.

1. System for Managing Public Cloud (1) comprising at least a software and hardware arrangement for Basic support (or package A), said arrangement enabling a user to connect to the system for creating at least an account and to execute or provide two of the following:
Display on user terminal digital configuration forms and to let fill up the forms by the user and memorize on the memory space attached to the user account such reply after validation by the user and offering options to select different service packages;
Enable Centralized Billing and Reporting;
Decide on Security Functionality required among selected choices made by user and memorized on the memory space attached to the user account;
Propose a Secured Global Account. (Owner Level) (Azure)
Propose a Secured Root Account (AWS)
Collect audit logs with secure storage and retention;
Determine Alert thresholds for giving Alert on Cloud Billing, said thresholds being determined by user and memorized on the memory space attached to the user account and to a service package selected.

2. System for Managing Public Cloud (1) according to claim 1, in which said arrangement enables said user to select at least one Standard Service Requests (SSRs) or at least one set of SSRs, said SSRs memorized on the memory space attached to the user account and to a service package selected.

3. System for Managing Public Cloud (1) according to claim 1 in which said arrangement is offering to a user the choice of a second option B (or package B) which allows the user to determine in addition: Automated creation and management of a virtual network environment with following minimal settings by using the memorized reply of a user for establishing:
Two availability zones: Public Subnet, Private Subnet
Internet Gateways
Static Firewall configurations
VPN/WAN Connectivity.

4. System for Managing Public Cloud (1) according to claims 1 in which said arrangement is offering to a user the choice of a third option C (or package C) which allows the user to determine in addition:
to control or execute all functionality via a Business Portal.
the Customizable approval workflows support customers governance (Azure®: T&M only)
select and execute Standard Service Requests allowing the control of various cloud services
to Compute Instances
to manage and control DB Instances (AWS® only)
to Compute Storage and backup functions (Azure®: restore within console—manually)
to determine the Firewall settings (policies)
to define the Load balancing configurations (AWS® only)
DNS (AWS® only)
to integrate all deployed objects into MPC management framework
to control for all objects monitoring, security and availability
to Compute Instances Operating system managed by customer or ordered on top of this Package.

5. System for Managing Public Cloud (1) according to claim 1, in which said arrangement offers the choice a few operational tasks performed by MPC-AWS® (2) which are listed such as:
Creation of new Virtual Private Cloud (VPC)'s
Creation of new Subnet's in VPC's
On-Going Management of Subnet's in VPC's
Documentation of Subnet usage and intended purposes
Creation of route tables
Creation of Security Groups as part of a project
Creation of Security Groups outside of a project.

6. Method for managing Public Cloud (1) which includes an hardware and software arrangement for executing at least one the following steps:
Displaying digital configuration forms and prompting user to fill up the forms
Deciding on Security Functionality required among selected choices
Propose a Secured Global Account. (Owner Level) (Azure®)
Propose a Secured Root Account (AWS®)
Collecting of audit logs with secure storage and retention
Determine Alert thresholds for giving Alert on Cloud Billing
Automated creation and management by MPC of a virtual network environment with following at least one of the minimal settings:
One repository created for the MPC Azure Product;
One repository created for the Customer Definitions and delta's.
Two availability zones: Public Subnet, Private Subnet
Internet Gateways
Static Firewall configurations
VPN/WAN Connectivity.

7. Method for managing Public Cloud (1) which includes an hardware and software arrangement for executing at least one the following steps:
Control or execute all functionality via Business Portal.
the Customizable approval workflows support customers governance (Azure®)
Select and execute Standard Service Requests allowing the control of various cloud services
Compute Instances
Manage and control DB Instances (AWS®)
Compute Storage and backup functions (Azure®: restore within console—manually)
Determine the Firewall settings (policies).
